(19) United States
(12) Patent Application Publication
(10) Pub. No.: US 2017/0238475 A1
(43) Pub. Date: Aug. 24, 2017

(54) ADAPTABLE GARDEN PLANTER BOX

(71) Applicant: Donald Wayne Van Pelt, Clearlake Oaks, CA (US)

(72) Inventor: Donald Wayne Van Pelt, Clearlake Oaks, CA (US)

(21) Appl. No.: 15/049,118

(22) Filed: Feb. 21, 2016

(51) Int. Cl. A01G 9/14; A01G 9/24; A01G 7/04

(52) U.S. Cl. CPC A01G 9/14; A01G 9/1407; A01G 7/045; A01G 9/247

(57) ABSTRACT

An expandable, portable, and semi-permanent garden planter box for the cultivation of plant life with an enclosable canopy for allowing limited control of the immediate atmospheric environment. The garden planter box is assembled from multiple component blocks capable of longitudinal and vertical integration providing the structural integrity of a solid structure and the adaptability and portability of structure composed of multiple interchangeable component parts capable of relatively easy assembly and disassembly without special tools or heavy equipment.

### FIELD OF THE PRESENT DISCLOSURE

This disclosure relates generally to a device for assisting with horticulture, and more particularly to an expandable, portable, semi-permanent planter box for creating a controlled environment, in regards to both soil and atmosphere, for the cultivation of plant life.

### BACKGROUND OF THE RELATED ART

Individuals interested in the cultivation of plant life of all varieties have always desired the ability to control the immediate environment of their flora of choice, both in regards to the soil and the atmosphere. Traditionally, in a rural setting, this is achieved by enhancing the local soil nutrients with various fertilizers or with non-local soils to cultivate particular advantageous properties and by controlling the soil moisture levels, whether by adding water or by allowing for proper drainage to remove access moisture. More advanced techniques also include atmospheric control, both in terms of air temperature and relative humidity. Transparent or translucent structures are sometimes utilized to enclose the cultivated plants allowing for some or all of the natural sunlight to penetrate for greater control of the plant's sunlight exposure and immediate atmosphere.

On a smaller, suburban scale, such structures are often called greenhouses. Greenhouses are structures that allow for the sunlight to penetrate the ceiling and/or walls but restrict the flow of air allowing for the atmosphere to be controlled both in terms of temperature and relative humidity. Greenhouses may either be built around a particular parcel of land in which the cultivated plants are directly planted, or they may have a proper building foundation requiring any cultivated plants growing within to be potted or placed inside a structure capable of retaining soil.

In either case, greenhouses are typically permanent structures that require a modest investment and require an individual to have a reasonable expectation that the land and space will not be needed for another purpose in the near future. If an individual is uncomfortable or unable to make plans with the requisite level of permanence then he or she may be not be able to invest in a greenhouse. It would be a significant convenience to such individuals if there existed a semi-permanent and/or portable solution that could assist in the cultivation of plants and be easily adaptable under changing circumstances.

Furthermore, the erection of permanent structures such as a greenhouse may require permission from a homeowners association, the city, or some other zoning authority. In today's increasingly urban and high-density society many property owners are subject to an increasing amount of prohibitive regulation from city, state, and local zoning authorities. In such situations, a semi-permanent and/or portable apparatus for the controlled cultivation of plants might allow such individuals to avoid much of the regulation and could prove to be a significant advantage.

Still further, a large number of individuals reside in rental properties, and therefore, have no authority to erect any permanent structures. These individuals might still be able to erect a structure for the cultivation of plant life if they could demonstrate that it could be disassembled and removed with ease and did not constitute a permanent addition or alteration to the property. There exists a need for such semi-permanent or portable devices for those who desire to erect an apparatus to assist with the cultivation of plant life in a controlled environment on leased or rented property.

Even those individuals who have the authority and resources to erect a greenhouse may have reservations because of its permanence of size and location. A greenhouse is not often easily expandable after it is erected and typically cannot be disassembled and moved without significant effort and probable damage. A semi-permanent, expandable, and/or portable apparatus for the cultivation of plant life in a controlled environment would be preferred by many such individuals.

Some individuals wish to cultivate plant life in locations without direct access to ground soil. This is increasingly true with the growing trend of urban farming. The spaces available to urban farmers are often unusual and nontraditional such as roof tops, patios, warehouses, and under-utilized parking lots. In spaces such as these, the soil must be wholly contained inside a portable structure. Traditionally, terracotta or ceramic pots or planters are used to hold soil above ground for plants.

However, if an individual is cultivating several plants, such a small garden, it may be more desirable and efficient to have a singular large structure with uniform soil nutrient and moisture characteristics, but such a structure is not often utilized because of the significant drawbacks related to its likely size, weight, and the difficulty of transportation. Depending on the physical restrictions of particular locations, such as roof tops or small patios, transporting a singular large structure may not be possible. There exists a need for a singular structure that may be dissembled into small component parts and reassemble at its final destination without heavy equipment or tools allowing for manageable transportation.

Further, in relation to urban farmers, space is typically highly limited, and therefore, highly valuable. Use of a plurality of terracotta or ceramic pots may not be an efficient use of space. Likewise, singular large structures may only be available in standard sizes that may not maximize the available footprint of unusual and/or nontraditional spaces that are often available. If a singular large structure is comprised of small interchangeable component parts, it could be customizable allowing for its shape and size to altered to best utilize all the available space for any particular location.

Whether for its semi-permanent nature, the flexibility of customizing and changing the size and shape of the structure, or its relative portability, there exists a need for an adaptable planter box for the cultivation plant life constructed from small interchangeable parts.

The present disclosure distinguishes over the related art providing heretofore unknown advantages as described in the following summary.

### SUMMARY OF THE INVENTION

The present disclosure relates to an expandable, portable, semi-permanent planter box for creating a controlled growing environment, in regards to both soil and atmosphere, for the cultivation of plant life.

The expandable, portable, semi-permanent planter box is constructed from a plurality of component blocks made from concrete or other material with similar structural qualities. The present disclosure teaches at least two varieties of blocks, a straight component block and corner component block. Each component block, whether straight or corner, features both a notch configuration and a key configuration on opposing longitudinal distal ends such that when any two component blocks are situated tightly adjacent each other, the notch and key configurations fit in a complimentary interlocking fashion. This longitudinal interlocking system allows each of two or more blocks to transfer lateral stress to the longitudinally adjacent block, thereby structurally behaving as if such longitudinally adjacent component blocks are one solitary block.

Using the desired number of straight component blocks and corner component blocks, an individual may assemble a planter box in a myriad of different shapes and of any practical size with relatively little effort. By placing each block longitudinally adjacent the next, when assembled, the longitudinal interlocking system will cause the entire planter box to behave structurally as if it were constructed from one solid block. This will allow the component blocks to collectively resist the lateral force of soil, fertilizer, water, and plant growth when the planter box is filled and utilized.

The component blocks are designed to be supportively integrated vertically as well. Each component block, whether straight or cornered, features at least two vertical holes located such that if an individual stacks a second layer of component blocks oriented in an overlapping or “running” fashion, the two vertical holes closest to the junction of two longitudinally adjacent component blocks will align with the two holes of the single component block situated above or below. After such alignment is made, an appropriately sized vertical reinforcement member may be inserted down through the aligned vertical holes of the stacked component blocks allowing vertically adjacent component blocks to transfer lateral stress, thereby acting as if vertically adjacent component blocks are one solitary block. This mechanism allows for the height of the planter box wall to be increased without loss of structural integrity.

Further embodiments may incorporate additional component block shapes, such as a curved component block, a decorative or rounded corner component block, or even specialty component blocks featuring integrated hardware such as a valve for a watering or fertilizing system or ab accommodation for electrical access for lighting. However, at a minimum, all component blocks must include the requisite features to facilitate either vertical or longitudinal integration or both so as to not compromise the overall structural integrity for the assembled planter box.

In some embodiments, the vertical reinforcement members are dowels or pipes constructed from polyvinyl chloride (PVC). Other embodiments may utilize bars or pipes constructed from a weather resistant metal such as aluminum. The material of construction of the vertical reinforcement members is not critical so long as they are appropriately sized to assist in the transfer of lateral stress between vertically adjacent component blocks and are of sufficient strength to withstand the shear stress created by the lateral force of the soil, fertilizer, water, and plant growth once the planter box is utilized.

In addition to vertically integrating the component blocks, the vertical reinforcement members can also provide the ribs for planter box's canopy. In most embodiments, the vertical reinforcement members extend up through the vertical holes of the vertically adjacent component blocks on one side of the planter box, form an arch, and extend down through the vertical holes of the vertically adjacent component blocks on the opposing side of the planter box. In this manner the vertical reinforcement members form a plurality of bowed ribs that serve as the physical structure for the planter box's canopy. In some embodiments, a transparent or translucent canopy integument is stretched across the plurality of bowed ribs forming an enclosure within which the plant life can be nurtured in a partially controlled environment with regards to both sunlight and atmosphere.

The choice of material from which to construct the canopy integument may vary widely depending on the particular desired plant-growing environment. For example, some embodiments may feature a transparent canopy integument to allow a maximum amount of sunlight exposure to reach the plant life to facilitate maximum photosynthesis while other canopy integuments may be opaque or varying degrees of translucent to protect sensitive varieties of plant life from the harshness of direct sunlight. Material qualities related to water permeability and heat transfer properties may also be considered when choosing an appropriate canopy integument material to allow an individual to control the relative humidity or shield the plant life from the temperature extremes of the external environment. Still other embodiment may feature no canopy integument at all choosing to expose the cultivated plant life to the external atmosphere. In such embodiments, the vertical reinforcement member may be truncated, existing entirely within the component blocks.

In some embodiments where water drainage or leaching would cause concern, damage, or would otherwise be unwanted, such as when the disclosed planter box is assembled on a rooftop or on a concrete floor of a warehouse, the planter box may include a water impermeable lining. In other embodiments, when such concerns do to exist, the soil and fertilizer may be filled in directly on top of the unmodified surface upon which the apparatus is assembled.

The multiple component block feature allows the disclosed planter box to be disassembled, transported, and/or modified quite easily without requiring the use of special tools or heavy equipment allowing the apparatus to be temporary and portable without compromising the strength and integrity provided by the vertical and longitudinal reinforcement features. Further, the individual component blocks are comparatively small allowing for assembly in even tight or relative inaccessible places. The presently disclosed apparatus provides individuals who would not be authorized or inclined to construct a comparably permanent structure access to an adaptable plant cultivation system.

This disclosure teaches certain benefits in construction and use which give rise to the objectives described below:

A primary objective is to provide an expandable, portable, semi-permanent planter box for the cultivation of plant life in a controlled environment;

Another objective is to provide an expandable, portable, semi-permanent planter box for the cultivation of plant life in a controlled environment that is easily customizable in terms of size and shape;

A further objective is to provide an expandable, portable, semi-permanent planter box for the cultivation of plant life in a controlled environment that may be disassembled, transported, and reassembled without the use of special tools or heavy equipment;

Other features and advantages of the present invention will become apparent from the following more detailed description, taken in conjunction with the accompanying drawings, which illustrates, by way of example, the principles of the presently described apparatus and method of use.

### BRIEF DESCRIPTION OF THE DRAWING(S)

The accompanying drawings are diagrams that illustrate various exemplary implementations and are part of the specification. The illustrated implementations are proffered for purposes of example, not for purposes of limitation. Illustrated elements will be designated by numbers. Once designated, an element will be identified by the identical number throughout. Illustrated in the accompanying diagram drawings is at least one of the best mode embodiments of the present disclosure. In such drawings:

FIG. 1 is a perspective view of an exemplary embodiment of the presently disclosed apparatus illustrated with a canopy integument fastened to minimize comingling of the interior and exterior atmosphere;

FIG. 2 is a perspective view of an exemplary embodiment of the presently disclosed apparatus illustrated with an aperture in the canopy integument fixed in an open orientation to encourage limited comingling of the interior and exterior atmosphere;

FIG. 3 is a perspective view of an exemplary embodiment of the presently disclosed apparatus shown without the canopy integument illustrating the plurality of arched structural reinforcement members designed both to provide shaped support for the canopy integument and to provide vertical unity and structural reinforcement to the structural blocks;

FIG. 4 is a perspective view of an exemplary embodiment of the presently disclosed apparatus shown without the canopy integument also featuring a sprinkler system integrated within the plurality of arched structural reinforcement members providing an overhead water distribution capabilities;

FIG. 5 is a perspective view of an exemplary embodiment of the presently disclosed apparatus shown without the canopy integument also featuring a planter box liner to prevent water leakage from within the planter box;

FIG. 6 is a perspective view of an exemplary embodiment of the presently disclosed apparatus shown without the plurality of arched structural reinforcement members or the canopy integument illustrating an embodiment with truncated structural reinforcement members located entirely within the structural blocks.;

FIG. 7 is a perspective view of a corner structural block component of the presently disclosed apparatus illustrating the notch and key longitudinal interlocking system, as well as, the holes designed to accept the structural reinforcement members to provide vertical unity to the structural blocks;

FIG. 8 is a perspective view of a straight structural block component of the presently disclosed apparatus illustrating the notch and key longitudinal interlocking system, as well as, the holes designed to accept the structural reinforcement members to provide vertical unity to the structural blocks;

### DETAILED DESCRIPTION OF DRAWINGS OF AN EXEMPLARY EMBODIMENT

The above described drawings illustrate an exemplary embodiment of an apparatus in at least one of its preferred, best mode embodiments, which is further defined in detail in the following description. Those having ordinary skill in the art may be able to make alterations and modifications to what is described herein without departing from the spirit and scope of the disclosure. Therefore, it must be understood that what is illustrated is set forth only for the purposes of example, and that it should not be taken as a limitation of the scope of the present apparatus or its method of use.

Described now in detail is the presently disclosed expandable, portable, semi-permanent planter box 100 for creating a controlled growing environment for the cultivation of plant life.

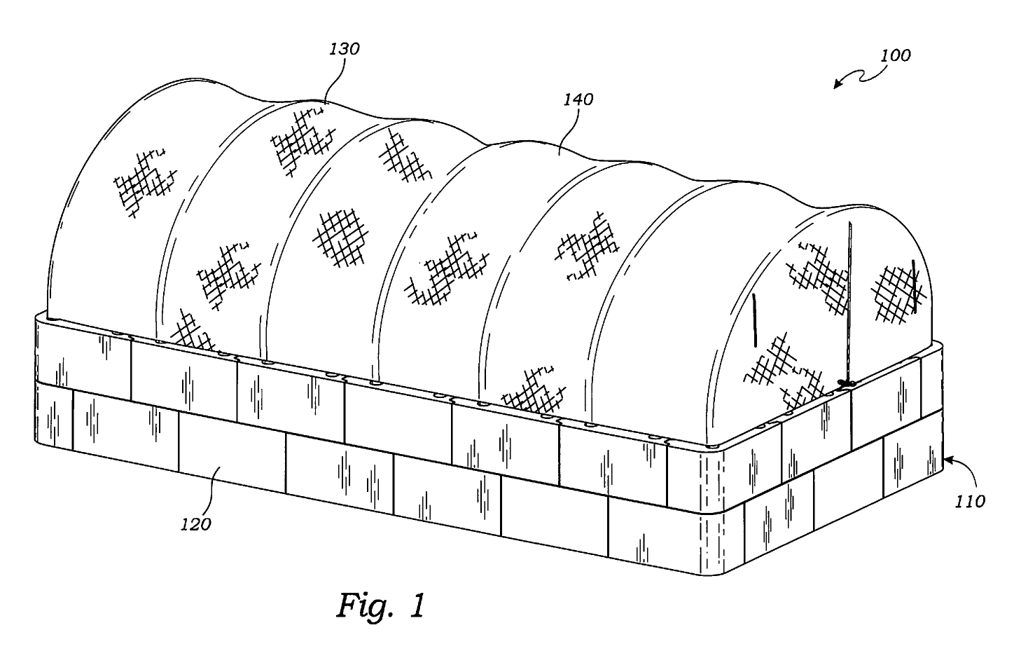

FIG. 1 illustrates an exemplary embodiment of the presently disclosed apparatus 100 featuring two layers of structural blocks 120,110 arranged in a closed rectangular orientation covered by a closed canopy integument 140 stretched over arched structural reinforcement members 130. The canopy integument 140 is illustrated in the completely closed orientation providing the maximum amount of isolation of the internal atmosphere from the external atmosphere. While the canopy integument 140 is not typically completely air tight, it can provide an important buffer preserving preferred internal atmospheric qualities such as temperature and relative humidity.

The canopy integument 140 may be constructed from a wide range of materials to assist in achieving and maintaining the preferred internal atmospheric qualities. For example, canopy integument 140 may be made of translucent plastic to provide the plant life within the maximum amount of sunlight exposure or it can be completely opaque to protect sensitive varieties of flora from the intensity of the midday sun. Similarly, whether the canopy integument 140 is made of impermeable plastic or loose knit canvas can have significant effects on the canopy integument's 140 ability to serve as buffer in regards to atmospheric qualities such as relative humidity and temperature.

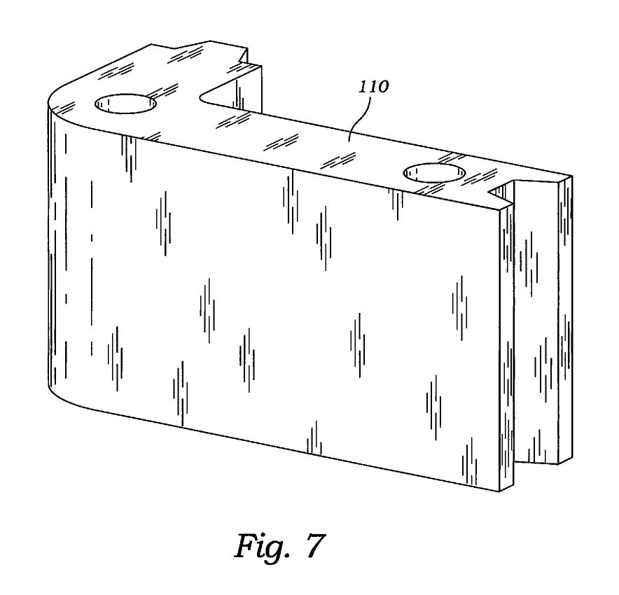

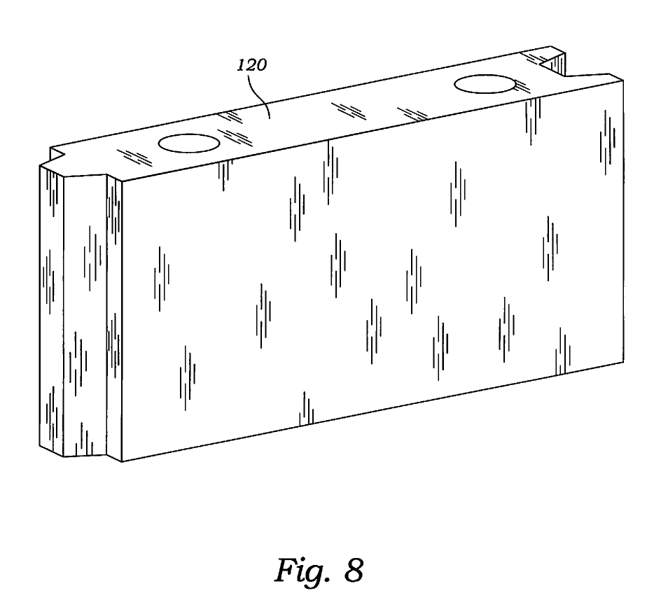

The structural blocks 120,110 illustrated in FIG. 1 are of two basic shape varieties; a straight structural block 120 (See FIG. 8) and a ninety degree corner structural block 110 (See FIG. 7). Structural blocks 120,110 of these shape varieties may be arranged to form any polygonal shape so long as the perimeter of structural blocks 120,110 is closed so that the interior space may be filled will soil for the cultivation of plant life. Other embodiments may include structural blocks 120,110 of additional shapes such as corner structural blocks 120,110 of more or less that ninety degrees or a curved or rounded corner structural block 120,110.

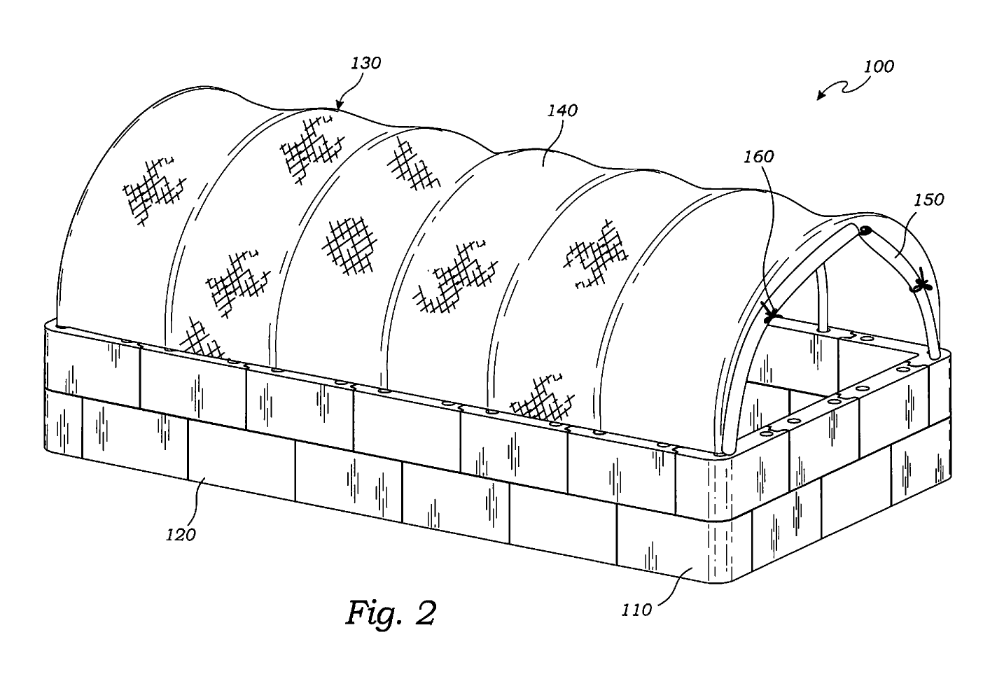

FIG. 2 illustrates the same exemplar apparatus 100 with a closeable aperture in the canopy integument currently in the open orientation. Such a feature allows for the partial mixing with outside atmosphere, which in some cases may be desirable.

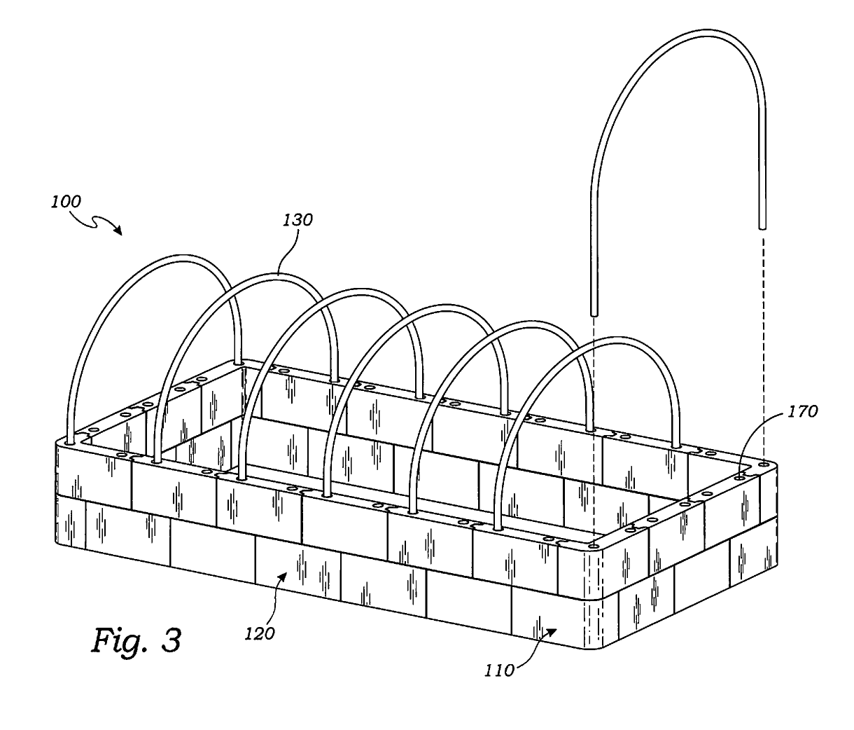

FIG. 3 illustrates the same exemplar apparatus 100 without the canopy integument 140 and provides greater visibility as to how the structural reinforcement members 130 couple with the structural blocks 120,110. Each structural block contains two vertical holes 170. If the each successive layer of structural blocks 120,110 are oriented in a staggered or “running” fashion the vertical holes 170 the structural blocks 120,110 from an inferior layer align with the vertical holes 170 in the structural block from a superior layer. The vertical reinforcement member may then be inserted into the holes 170 providing the ability of vertically adjacent structural blocks 120,110 to transfer lateral stress to a superior structural block 120,110 and vice versa.

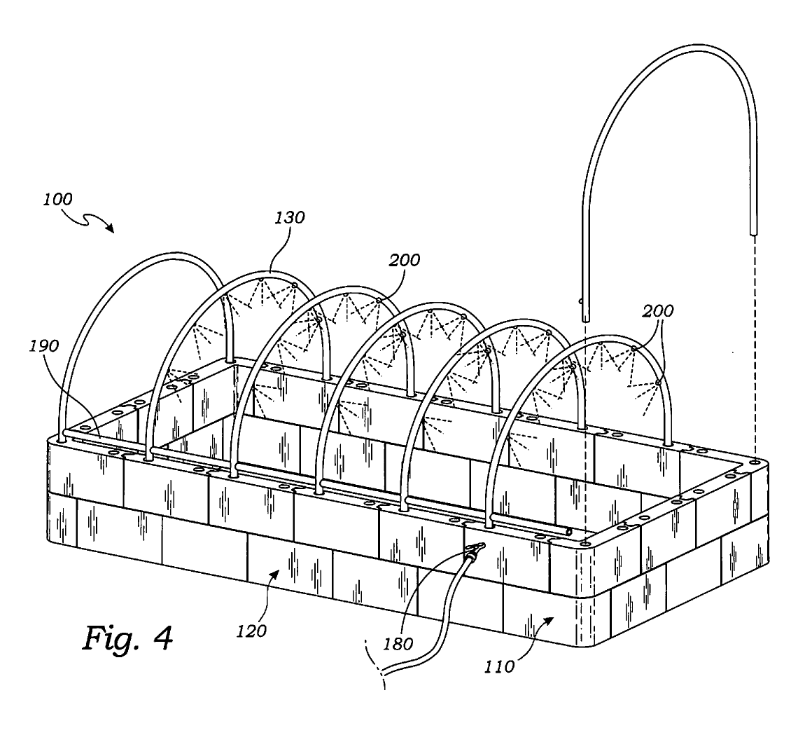

FIG. 4 illustrates further features such a watering system including spray nozzles 200 that can incorporated within the vertical reinforcement members 130. Other embodiments may include artificial lighting for either increased photosynthesis or the inclusion of heating elements to assist in maintaining a desired temperature within the apparatus 100. The electrical access can be configured in the same manner that the water access 180 is illustrated in FIG. 4.

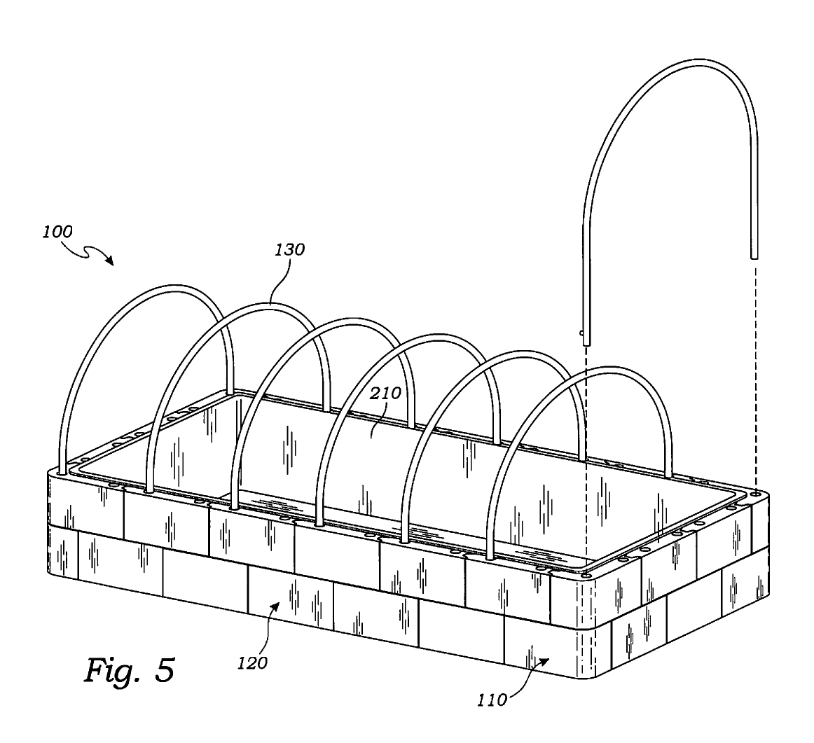

FIG. 5 illustrates further optional features such as a water impermeable liner 210 located within the enclosure defined by the perimeter of structural blocks 120,110. A water impermeable liner 210 is an important feature when the apparatus is assembled in a location where water leakage would be damaging or undesired such as on a rooftop or indoors.

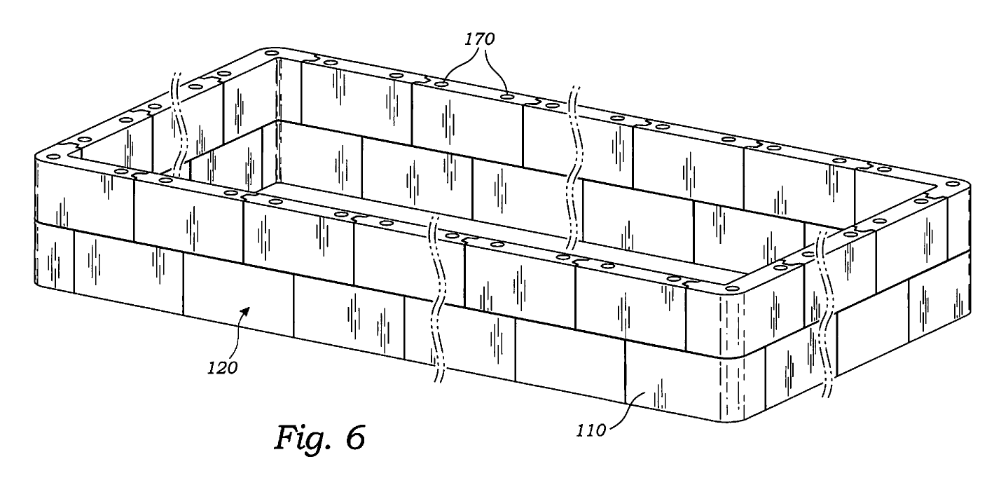

FIG. 6 illustrates and embodiment without arched structural reinforcement members or a canopy integument 140. In such cases the structural reinforcement members 130 may be truncated so that the structural reinforcement members 130 exist entirely within the vertical holes 170 of structural blocks and are not externally visible.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventors believe that the claimed subject matter is what is intended to be patented.

What is claimed is:

1. An expandable, portable, semi-permanent garden planter box apparatus for the cultivation of plant life, said apparatus comprising:
a plurality of structural blocks positioned longitudinally adjacent to each other forming an enclosed area capable of supporting soil for the cultivation of plant life defined by a closed perimeter of structural blocks, each said structural block featuring both a notch configuration and a key configuration on opposing longitudinal distal ends such that when any two structural blocks are situated tightly adjacent to each other, the notch and key configurations fit together in a complimentary interlocking fashion allowing each structural block to transfer lateral stress to any longitudinally adjacent structural block, and each said structural block also featuring two vertical holes spaced such that the distance between the two vertical holes in each structural block is equal to the space between each vertical hole and the nearest vertical hole in any longitudinally adjacent structural block;

2. An apparatus as in claim 1 further comprising at least one plurality of superior positioned structural blocks forming an additional layer of structural blocks, each additional layer of structural blocks comprising a plurality of structural blocks positioned longitudinally adjacent to each other and supported by the immediately inferior positioned structural blocks, said superiorly positioned structural blocks arranged in a running or staggered orientation with respect to said inferior positioned structural blocks such that each vertical hole in said plurality of superiorly positioned structural block is aligned with a vertical hole in separate adjacently positioned inferiorly positioned structural blocks;
a plurality of reinforcement members, said plurality of reinforcement members positioned inside each aligned vertical hole and of sufficient length to extend from at least the inferior distal end of the vertical hole in said inferior structural blocks to the superior distal ends of the vertical hole in said superior structural blocks allowing each structural block to transfer lateral stress to vertically adjacent structural blocks, whether positioned superiorly or inferiorly.

3. An apparatus as in claim 2 wherein said plurality of reinforcement members, each said reinforcement member extending from the inferior distal end of the vertical hole in said inferior structural block, up through the aligned vertical holes in any superiorly positioned structural blocks forming an arch and extending down through the aligned vertical holes in any structural blocks on the opposing side of said closed perimeter of structural blocks terminating at the inferior distal end of the vertical hole in the inferior structural block on the opposing side of said closed perimeter of structural blocks forming an arch.

4. An apparatus as in claim 3 further comprising a canopy integument stretched over and supported by said plurality of arched reinforcement members, extending down to the superior surface of said superior positioned structural blocks around said closed perimeter of structural blocks creating an enclosure over said closed perimeter of structural blocks for controlling the luminary and atmospheric conditions within the enclosure for the cultivation of plant life.

5. An apparatus of claim 4 whether said integument features closable apertures in said canopy integument allowing for greater control over the luminary and atmospheric conditions within the enclosure for the cultivation of plant life.

6. An apparatus as in claim 3 wherein said reinforcement members are hollow and feature a plurality of inferiorly oriented sprinkler nozzles such that water may be delivered through the hollow center of said reinforcement members and exit through said sprinkler nozzles to distribute water on the plant life below.

7. An apparatus as in claim 3 wherein said reinforcement members are hollow and feature a plurality of inferiorly oriented light sources such that electrical wiring may be run through the hollow center of said reinforcement members providing power for plurality of downward oriented light sources to distribute light on the plant life below.

8. An apparatus as in claim 2 further comprising a water impermeable liner located internal to said closed perimeter of structural blocks extending throughout the area defined by said closed perimeter of structural blocks and up along the internal surface of said closed perimeter of structural blocks for preventing water leakage from the soil located within the closed perimeter of structural blocks for the cultivation of plant life.
